(19) United States
(12) Patent Application Publication
(10) Pub. No.: US 2008/0122790 A1
(43) Pub. Date: May 29, 2008

(54) Optical handwriting input device

(75) Inventors: Chia-Chu Cheng, Hsin-Tien City (TW); Ya-Lun Lee, Hsin-Tien City (TW); Yu-Wei Lu, Hsin-Tien City (TW)

Correspondence Address: ROSENBERG, KLEIN & LEE, 3458 ELLICOTT CENTER DRIVE-SUITE 101, ELLICOTT CITY, MD, 21043, US

(73) Assignee: LITE-ON SEMICONDUCTOR CORPORATION

(21) Appl. No.: 11/604,796

(22) Filed: Nov. 28, 2006

(51) Int. Cl. G06F 3/033; G09G 5/00; G06F 3/041

(52) U.S. Cl. 345/164; 345/156; 345/173

(57) ABSTRACT

An optical handwriting input device includes: a casing, a refill, a PCB, an image data communication module, and a motion detection module. The refill received in the casing has a pen nib, and the pen nib is selectably exposed from a bottom side of the casing or hidden inside the casing. The PCB is received in the casing and disposed beside one side of the pen refill. The image data communication module is received in the casing and electrically connected to the PCB. The motion detection module is received in the casing and electrically connected to the PCB. Hence, the present invention can detect the movement track of the optical handwriting input device by receiving a light-reflecting signal from a detection surface, and the movement track is identified and inputted to a digital electronic device to become handwriting displayed on a monitor of the digital electronic device.

### BACKGROUND OF THE INVENTION

1. Field of the Invention

The present invention relates to an optical handwriting input device, and particularly relates to an optical handwriting input device that can track the movement of the optical handwriting input device by receiving a light-reflecting signal from a detection surface. The movement track is identified and inputted to a digital electronic device to become handwriting shown on the monitor of the digital electronic device.

2. Description of the Related Art

A known handwriting input device is composed of a magnetic handwriting digital panel and a touch pen. Alternatively, it is composed of a digital panel with an LCD and a touch pen.

Referring to FIG. 1, when the known magnetic handwriting digital panel B and touch pen P are in use, the touch pen P does not write down anything on the digital panel B. The tacks or handwritings are displayed on a monitor M that connects to a computer host C. For example, when user uses the touch pen P to write the word “A” on the digital panel B, the word of “A” is shown on the monitor M via the computer host C. However, when the user uses the touch pen P to write the number of strokes required for a character or a picture, the strokes are not continuous. Hence, the strokes can not be shown correctly on the monitor M. It is inconvenient for user.

Furthermore, although a digital panel with an LCD can show all strokes on the LCD, the digital panel with the LCD is expensive. The cost is not affordable for most users.

Moreover, according to the above-mentioned method, no matter which method is used, the touch pen always needs to work in tandem with the digital panel. Hence, not only is the cost increased, but it is also inconvenient for the user to carry both the panel and the touch pen around together.

### SUMMARY OF THE INVENTION

The present invention provides an optical handwriting input device that can detect the movement track of the optical handwriting input device by receiving a light-reflecting signal from a detection surface. The movement track is then identified and inputted to a digital electronic device to become handwriting shown on the monitor of the digital electronic device. Hence, because the present invention omits the known digital panel, not only is the cost decreased, but also it is more convenient for the user to carry around with them.

One aspect of the invention is an optical handwriting input device, comprising: a casing, a refill, a PCB, an image data communication module, and a motion detection module. The refill is received in the casing and has a pen nib, and the pen nib is selectably exposed from a bottom side of the casing or hidden inside the casing. The PCB is received in the casing and disposed beside one side of the pen refill. The image data communication module is received in the casing and electrically connected to the PCB. The motion detection module is received in the casing and electrically connected to the PCB.

Moreover, the motion detection module comprises: a light-emitting unit, a sensor control unit, an image-sensing unit, a data-storing unit, and an operation unit. The light-emitting unit is used for projecting a light source onto a detection surface to generate a light-reflecting signal. The sensor control unit is used for providing a system timing clock. The image-sensing unit is electrically connected to the sensor control unit for sensing the light-reflecting signal. The data-storing unit is electrically connected to the sensor control unit for storing the light-reflecting signal from the image-sensing unit. The operation unit is electrically connected to the sensor control unit and the data-storing unit, wherein a motion direction and a motion velocity of the optical handwriting input device relative to the motion surface is established by the operation unit according to the light-reflecting signal from the image-sensing unit.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The various objects and advantages of the present invention will be more readily understood from the following detailed description when read in conjunction with the appended drawings, in which:

FIG. 1 is a schematic view of a digital panel matched with a touch pen according to a prior art;

FIG. 2 is a cross-sectional, schematic view of an optical handwriting input device according to the first embodiment of the present invention;

FIG. 3 is a function block of a motion detection module according to the first embodiment of the present invention;

FIG. 4 is a cross-sectional, schematic view of an optical handwriting input device according to the second embodiment of the present invention;

FIG. 5 is a cross-sectional, schematic view of an optical handwriting input device according to the third embodiment of the present invention;

FIG. 6 is a first schematic view of an optical handwriting input device of the present invention applied as a mouse; and

FIG. 7 is a second schematic view of an optical handwriting input device of the present invention applied as a mouse.

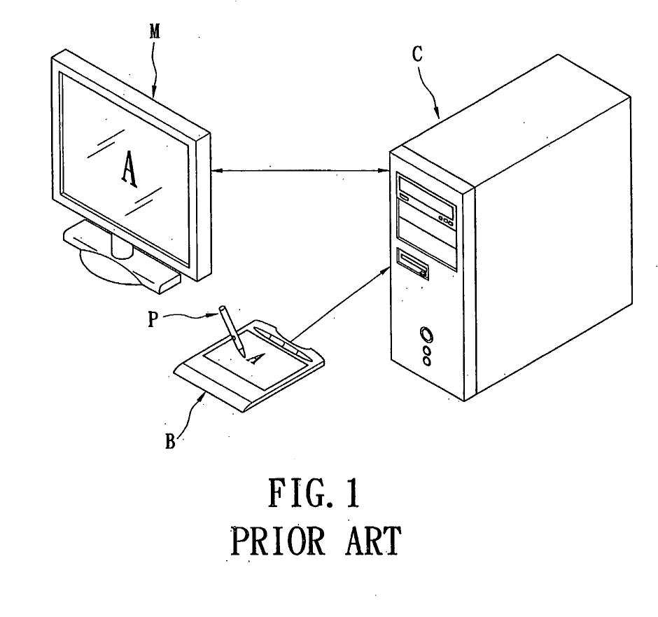

### DETAILED DESCRIPTION OF PREFERRED EMBODIMENTS

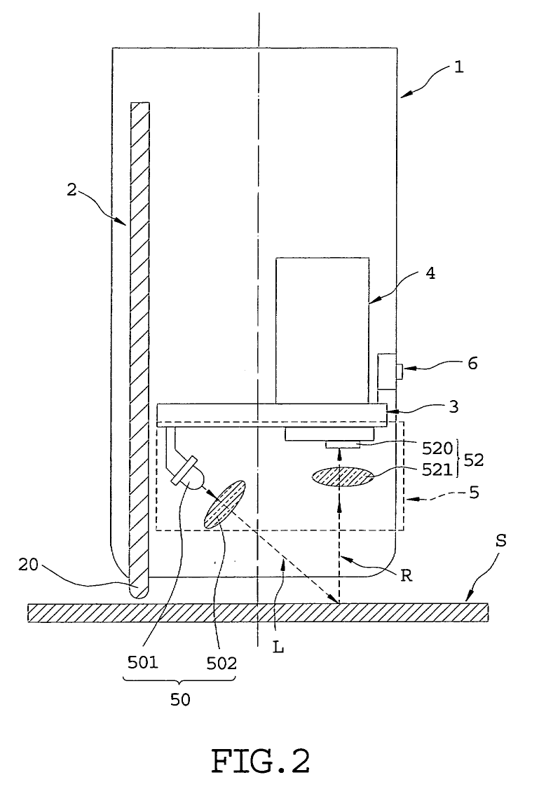

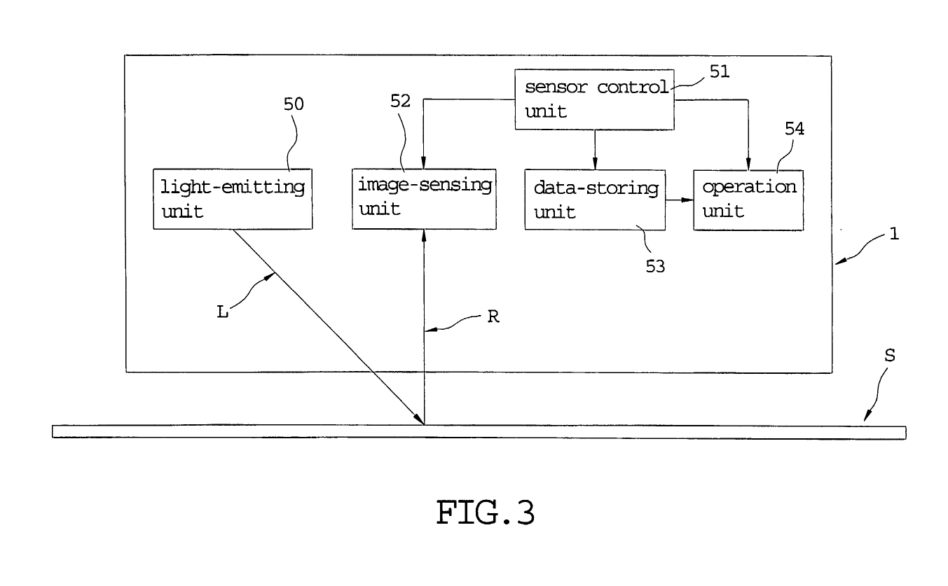

Referring to FIGS. 2 and 3, the present invention of the first embodiment provides an optical handwriting input device, comprising: a casing 1, a refill 2, a PCB 3, an image data communication module 4, and a motion detection module 5.

The casing 1 is similar in size to a common pen. The refill 2 is received in the casing 1 and has a pen nib 20, and the pen nib 20 is selectably exposed from a bottom side of the casing 1 or hidden inside the casing 1. In addition, the pen nib 20 can be a pen point, a pencil point or any other known points that a user might use for writing conveniently.

Moreover, the PCB 3 is received in the casing 1 and disposed beside one side of the pen refill 2. The image data communication module 4 is received in the casing 1 and electrically connected to the PCB 3. The motion detection module 5 is received in the casing 1 and electrically connected to the PCB 3.

The motion detection module 5 comprises: a light-emitting unit 50, a sensor control unit 51, an image-sensing unit 52, a data-storing unit 53, and an operation unit 54. The light-emitting unit is used for projecting a light source L onto a detection surface S to generate a light-reflecting signal R. The sensor control unit 51 is used for providing a system timing clock. In addition, the image-sensing unit 52 is electrically connected to the sensor control unit 51 for sensing the light-reflecting signal R.

The light-emitting unit 50 can rotate between 0˜90 degrees relative to a central axle of the casing 1. The light-emitting unit 50 is composed of a light-emitting element 501 and a collimation lens 502. A mirrored surface of the collimation lens 502 can be a spherical surface or an aspheric surface. The light-emitting element 501 can be a coherent light-emitting element or a noncoherent light-emitting element.

If the light-emitting element 501 is a coherent light-emitting element the light-emitting unit 50 is composed of a coherent light-emitting element and a collimation lens 502. The coherent light-emitting element is composed of one or many lasers or VCSELs (Vertical Cavity Surface-Emitting Lasers). If the light-emitting element 501 is a noncoherent light-emitting element the light-emitting unit 50 is composed of a noncoherent light-emitting element and a collimation lens 502, and the noncoherent light-emitting element is composed of one or many LEDs.

The image-sensing unit 52 can rotate between 0˜90 degrees relative to a central axle of the casing 1. The image-sensing unit 52 is composed of a linear sensor array 520 (or many linear sensor arrays) and an imaging lens 521.

The data-storing unit 53 is electrically connected to the sensor control unit 51 for storing the light-reflecting signal R from the image-sensing unit 52. The data-storing unit 53 can also be electrically connected (not shown in FIG. 3) to the image sensing unit 52. The operation unit 54 is electrically connected to the sensor control unit 51 and the data-storing unit 53. Hence, a motion direction and a motion velocity of the optical handwriting input device relative to the motion surface S is established by the operation unit 54 according to the light-reflecting signal R from the image-sensing unit 52.

The optical handwriting input device further comprises a switch module 6 disposed on the casing 1 and electrically connected to the PCB 3. The switch module 6 has a digital pen/mouse function-switching mold. In other words, the switch module 6 can be switched so that the optical handwriting input device can be used for different usage functions such as a digital pen function or a mouse function according to the user's needs.

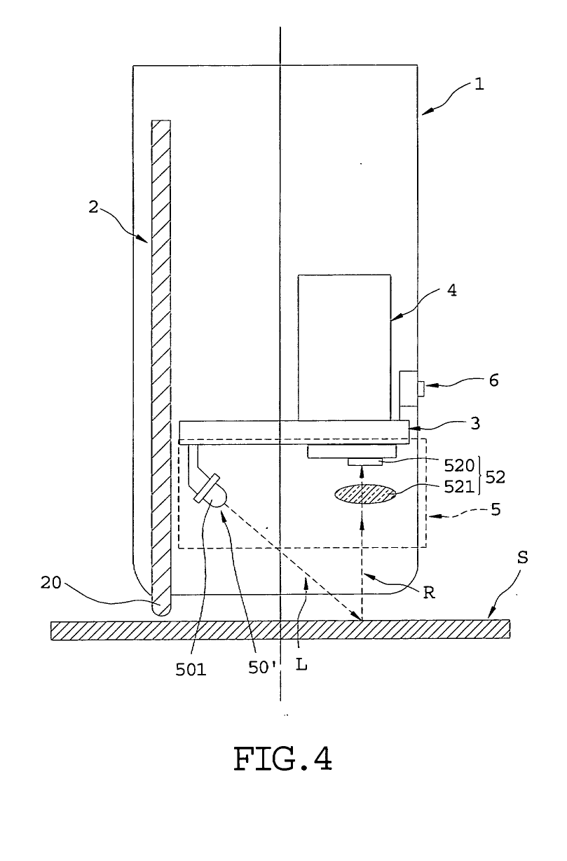

Referring to FIG. 4, the difference between the second embodiment and the first embodiment is that in the second embodiment the light-emitting unit 50′ is the light-emitting element 501 (omitting the collimation lens 502 of the first embodiment). A light source of the light-emitting unit 50′ can be a coherent light source or a noncoherent light source. In other words, the light-emitting element 501 can be a coherent light-emitting element or a noncoherent light-emitting element.

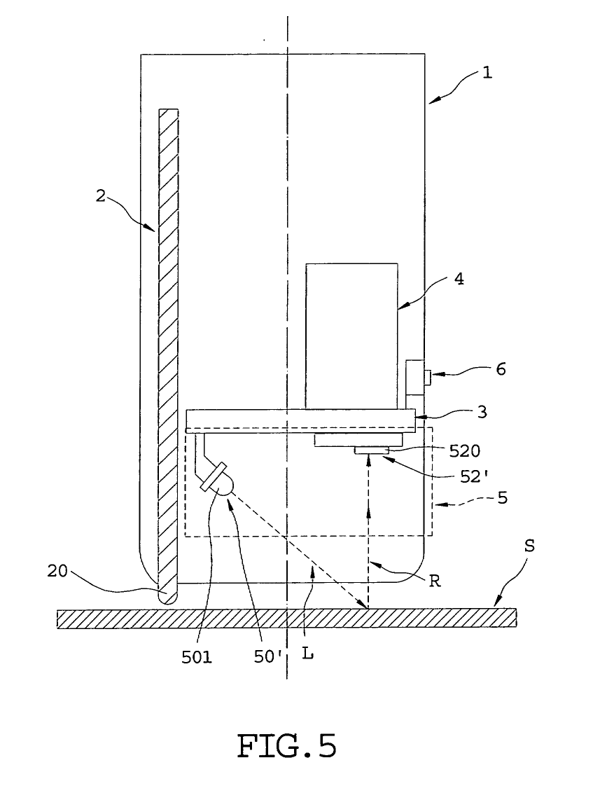

Referring to FIG. 5, the difference between the third embodiment and the second embodiment is that in the third embodiment the imaging lens 521 (as shown in FIG. 4.) is omitted. Hence, the image-sensing unit 52′ is a linear sensor array 520 (or a number of linear sensor arrays).

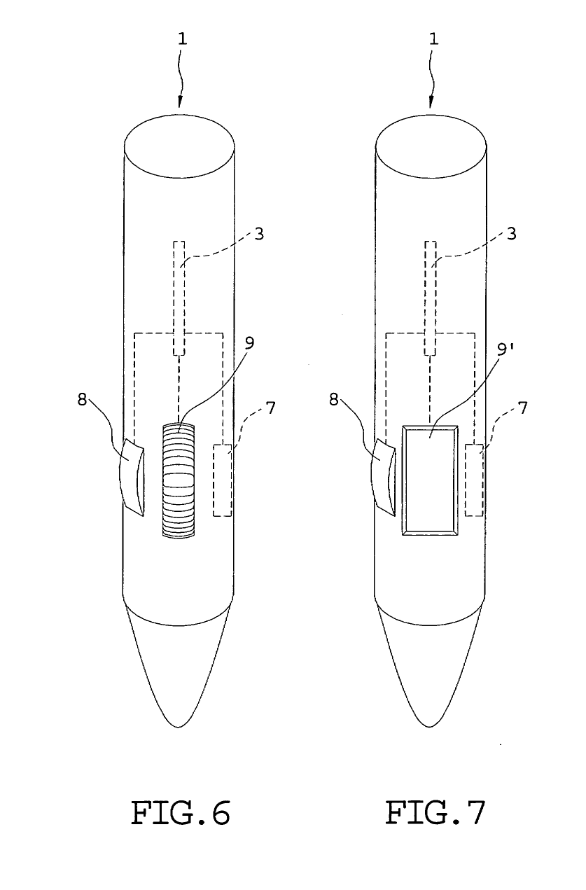

Referring to FIG. 6, in another embodiment the optical handwriting input device further comprises a first button 7 (similar to the function of a left button of a traditional mouse) disposed in the casing 1 for measuring downward pressure placed upon the pen nib 20, a second button 8 (similar to the function of a right button of a traditional mouse) exposed outside the casing 1, and a roller 9 (similar to rolling function of a traditional mouse) exposed outside the casing 1 for performing a rolling function. All three function buttons (the first button 7, the second button 8, and the roller 9) are connected with the PCB 3.

Referring to FIG. 7, in another embodiment the optical handwriting input device further comprises a first button 7 (similar to the function of a left button function of a traditional mouse) disposed in the casing 1 for measuring downward pressure placed upon the pen nib 20, a second button 8 (similar to the function of a right button of a traditional mouse) exposed outside the casing 1, and a touch pad 9′ (similar to the rolling function of a traditional mouse) exposed outside the casing 1. All three function buttons (the first button 7, the second button 8, and the touch pad 9′) are connected with the PCB 3.

In conclusion, the present invention provides an optical handwriting input device that can detect the movement track of the optical handwriting input device by receiving a light-reflecting signal R from a detection surface S. The movement track is identified and inputted to a digital electronic device (not shown) such as a computer or a PDA in either a wireless or a wired manner (such as through a USB or via Bluetooth) to become handwriting that is displayed on a monitor (not shown in the drawings) of the digital electronic device. Hence, because the present invention omits the known digital panel, not only are costs decreased, but it is also more convenient for a user to carry around.

The size of the optical handwriting input device of the present invention is similar to that of a common pen. The optical handwriting input device does not need to be used on a special surface. Hence, the present invention has some advantages, as follows:

1. The present invention can be applied to any surface, so that the optical handwriting input device has an extensive usage scope.

2. The present invention omits the known heavy digital panel, so that it is convenient for a user to carry the optical handwriting input device.

3. The present invention can be used as a traditional mouse, so that the optical handwriting input device is a multipurpose device.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An optical handwriting input device, comprising:
a casing;
a refill received in the casing and having a pen nib, wherein the pen nib is selectably exposed from a bottom side of the casing or hidden inside the casing;
a PCB received in the casing and disposed beside one side of the pen refill;
an image data communication module received in the casing and electrically connected to the PCB; and
a motion detection module received in the casing and electrically connected to the PCB, wherein the motion detection module comprises:
a light-emitting unit for projecting a light source to a detection surface to generate a light-reflecting signal;
a sensor control unit for providing a system timing clock;
an image-sensing unit electrically connected to the sensor control unit for sensing the light-reflecting signal;
a data-storing unit electrically connected to the sensor control unit for storing the light-reflecting signal from the image-sensing unit; and
an operation unit electrically connected to the sensor control unit and the data-storing unit, wherein a motion direction and a motion velocity of the optical handwriting input device relative to the motion surface is established by the operation unit according to the light-reflecting signal from the image-sensing unit.

2. The optical handwriting input device as claimed in claim 1, wherein the pen nib is a pen point or a pencil point.

3. The optical handwriting input device as claimed in claim 1, wherein the light-emitting unit is a coherent light-emitting element.

4. The optical handwriting input device as claimed in claim 3, wherein the coherent light-emitting element is composed of one or a number of lasers or VCSELs (Vertical Cavity Surface-Emitting Lasers).

5. The optical handwriting input device as claimed in claim 1, wherein the light-emitting unit is composed of a coherent light-emitting element and a collimation lens.

6. The optical handwriting input device as claimed in claim 5, wherein a mirrored surface of the collimation lens is a spherical surface or an aspheric surface.

7. The optical handwriting input device as claimed in claim 1, wherein the light-emitting unit is a noncoherent light-emitting element.

8. The optical handwriting input device as claimed in claim 7, wherein the noncoherent light-emitting element is composed of one or many LEDs.

9. The optical handwriting input device as claimed in claim 1, wherein the light-emitting unit is composed of a noncoherent light-emitting element and a collimation lens.

10. The optical handwriting input device as claimed in claim 9, wherein a mirrored surface of the collimation lens is a spherical surface or an aspheric surface.

11. The optical handwriting input device as claimed in claim 1, wherein the image-sensing unit is composed of one or many linear sensor arrays.

12. The optical handwriting input device as claimed in claim 1, wherein the image-sensing unit is composed of a linear sensor array and an imaging lens.

13. The optical handwriting input device as claimed in claim 1, wherein the light-emitting unit is rotated between 0˜90 degrees relative to a central axle of the casing.

14. The optical handwriting input device as claimed in claim 1, wherein the image-sensing unit is rotated between 0˜90 degrees relative to a central axle of the casing.

15. The optical handwriting input device as claimed in claim 1, further comprising a switch module disposed on the casing and electrically connected to the PCB, wherein the switch module has a digital pen/mouse function-switching mold.

16. The optical handwriting input device as claimed in claim 1, further comprising a first button disposed in the casing for measuring downward pressure placed upon the pen nib and a second button exposed outside the casing, wherein both the first button and the second button are connected with the PCB.

17. The optical handwriting input device as claimed in claim 1, further comprising a roller or a touch pad for performing a rolling function, wherein the roller or the touch pad is exposed outside the casing and electrically connected with the PCB.
